(19) United States
(12) Patent Application Publication
(10) Pub. No.: US 2005/0146261 A1
(43) Pub. Date: Jul. 7, 2005

(54) Display device

(76) Inventors: Emiko Hayakawa, Kyonan (JP); Yoshihiro Koseki, Chiba (JP); Naomitsu Watanabe, Mobara (JP); Hidetsugu Matsukiyo, Chiba (JP)

Correspondence Address: Milbank, Tweed, Hadley & McCloy, LLP, One Chase Manhattan Plaza, New York, NY, 10005, US

(21) Appl. No.: 10/996,488

(22) Filed: Nov. 24, 2004

(30) Foreign Application Priority Data
Nov. 28, 2003 (JP) 2003-398566

(51) Int. Cl. H01J 29/10

(52) U.S. Cl. 313/479; 313/469; 313/461

(57) ABSTRACT

A reflection film for reflecting electron beams is provided between an inner surface of a face plate and a phosphor layer. The electron beams which pass through a phosphor layer are reflected on the reflection film and are incident on the phosphor layer. Since the electron beams are reflected on the reflection film, the browning of the face plate can be decreased.

### BACKGROUND OF THE INVENTION

1. Field of the Invention

The present invention relates to a display device, and more particularly to a display device which can suppress a coloring phenomenon of a panel glass attributed to the radiation of electronic beams and can prevent the deterioration of brightness attributed to discoloring with time.

2. Description of Related Art

As a display device, there has been known a projection type television device which uses a projection type cathode ray tube, for example. In the projection type television device, three projection type cathode ray tubes for a green image, for a blue image and a red image are arranged at a position away from a projection screen by a given distance and reproduced images which are displayed on face plates of three projection type cathode ray tubes are projected and displayed on a video screen in an overlapped manner through projection lenses.

The projection type cathode ray tube is constituted of a glass-made vacuum envelop, a panel portion having a faceplate, an elongated cylindrical neck portion which houses an electron gun in the inside thereof, and an approximately funnel-like funnel portion which connects the panel portion and the neck portion.

Further, in this projection type cathode ray tube, a phosphor layer is formed on an inner surface of the face plate of the panel portion. Electron beams of high density emited from the electron gun are deflected by vertical and horizontal deflection magnetic fields which are formed by a deflection yoke and perform two-dimensional scanning of the phosphor layer. Light which is generated by the impingement of the electron beams on a phosphor is projected to a video screen in an enlarged manner using a projection lens.

When the electron beams of high density are incident on a phosphor layer, there exist some electron beams which do not impinge on phosphor particles in the inside of the phosphor layer and do not contribute to the emission of light of the phosphor. Further, there exist some electrons which pass through among the phosphor particles while being scattered and impinge on the face plate. Accordingly, the face plate generates browning. The browning is a phenomenon in which the electron beams impinge on the face plate and the face plate per se becomes brownish.

In this manner, due to the presence of a relatively large number of electron beams which do not contribute to the emission of light of the phosphor particles in the electron beams and the impingement of such electron beams which do not contribute to the emission of light on the face plate, the browning is generated on the face plate and hence, it is difficult to obtain the projection type cathode ray tubes having a bright display image.

Further, when such browning is generated on the faceplate, the face plate particularly absorbs light in a region from green to blue. Accordingly, the browning has been one of factors which prevent the extension of life time of the green projection type cathode ray tube and the blue projection type cathode ray tube.

Here, the generation of browning is not limited to the above-mentioned projection type cathode ray tubes and the browning is generated with respect to a field emission type image display device, a display monitor tube, a television receiver set, other cathode ray tubes, a cathode ray tube which does not include phosphor in an inner surface of a panel glass or a cathode ray tube having a layer other than phosphor.

Japanese Unexamined Patent Publication Hei6 (1994)-76754 (patent document 1) discloses a technique to cope with this type of browning. That is, in this patent document 1, there is disclosed the technique in which a phosphor slurry containing bismuth oxide (Bi₂O₃) particles is rotatably applied to form an applied film at the time of forming a phosphor screen on an inner surface of a face plate of a panel portion, the applied film is exposed to light using a shadow mask and, thereafter, is developed using pure water, and remaining exposed portions are dried to form a phosphor layer. In this case, bismuth oxide (Bi₂O₃) particles which have a large specific weight are firstly deposited on an inner surface of the face plate thus forming a phosphor screen having the two-layered structure consisting of a reflection layer film and the phosphor layer containing bismuth oxide (Bi₂O₃) particles as a main component.

Further, Japanese Unexamined Patent Publication Hei10 (1998)-302681 (patent document 2) discloses another technique to cope with the browning. In this technique, a reflection film containing bismuth oxide (Bi₂O₃) particles as a main component thereof is formed on an inner surface of a face plate of a panel portion, a first solution which mixes a trace amount of barium acetate solution and pure water therein and a second solution which mixes a suspension which suspends phosphor particles in pure water and potassium silicate (water glass) solution which constitutes a binder material therein are injected into the reflection film, and this state is held for 5 to 10 minutes in a still state. Thereafter, a valve structural body is inclined to discharge the solution which is filled in the valve structural body, air is sprayed onto a formed phosphor layer for drying the phosphor layer thus forming a phosphor layer and, thereafter, an aluminum vapor deposition film is formed on the phosphor layer.

### SUMMARY OF THE INVENTION

In a color cathode ray tube described in the patent document 1, with respect to the reflection film which is formed on the inner surface of the face plate, bismuth oxide (Bi₂O₃) particles and the phosphor layer are formed simultaneously. Accordingly, boundaries between the reflection film layer and three-color phosphor layers are not clear and hence, it is difficult to reflect most of the electron beams which pass through the phosphor layer in the phosphor layer direction by the reflection film layer. In an attempt to directly apply this technical means to the projection type cathode ray tube as it is, compared to a projection energy of electron beams of the color cathode ray tube, the projection energy of electron beams of the projection-type cathode ray tube is high and hence, it is difficult to allow most of the electron beams to be reflected on the reflection film layer and hence, there still remains the drawback that it is impossible to obtain the projection type cathode ray tube which has the sufficiently bright phosphor screen.

Further, in the projection type cathode ray tube described in the patent document 2, the reflection film used as the reflection film layer is formed on the inner surface of the face plate of the panel portion by spraying bismuth oxide (Bi₂O₃). However, the bismuth oxide (Bi₂O₃) particles are liable to be easily coagulated and, particularly, it is difficult to achieve the stable dispersion in the inside of the binder. Further, in the spray method, it is difficult to form a film made of particles having a uniform thickness and hence, there has been a drawback that irregularities in thickness is liable to occur with respect to a formed reflection film thus partially lowering the transmissivity. Further, the reflection layer is a film which is formed of white bismuth oxide (Bi₂O₃) particles and hence, it is fundamentally difficult to increase the optical transmissivity.

The present invention has been made to overcome the above-mentioned drawbacks and it is an object of the present invention to provide a display device which can largely enhance the brightness of a display image by reducing the browning generated on a face plate attributed to the projection of electron beams thus enhancing the optical transmissivity.

In the display device according to the present invention, a vapor deposition film for reflecting electron beams is provided between an inner surface of a light transmitting panel glass and a phosphor layer. By allowing electron beams projected to the panel glass to be reflected on the vapor deposition film, the browning can be reduced.

A metal compound which constitutes the vapor deposition film is preferably a compound of a metal element whose atomic number exceeds 70.

Further, the metal compound which constitutes the vapor deposition film is bismuth oxide.

Further, a film thickness of the vapor deposition film falls in a range of 0.01 to 10.0 μm.

Still further, the optical transmissivity of the vapor deposition film is 80% or more.

The present invention is not limited to the above-mentioned respective constitutions and constitutions of embodiments described later and various modifications are conceivable without departing from the gist of the present invention.

The display device of the present invention includes the vapor deposition film for reflecting electron beams between the inner surface of the light transmitting panel glass and the phosphor layer. Due to such a constitution, it is possible to reduce the browning which is generated on the panel glass attributed to the impingement of electron beams. Further, it is possible to obtain excellently advantageous effects that a light emitting quantity on the phosphor layer can be largely increased and, at the same time, the sufficient brightness can be maintained even when the electron beams are projected for a long time.

### BRIEF DESCRIPTION OF THE DRAWINGS

FIG. 1 is a cross-sectional view showing an essential part of the constitution of a projection type cathode ray tube according to one embodiment of a display device of the present invention;

FIG. 2 is an enlarged cross-sectional view showing a portion A of the projection type cathode ray tube shown in FIG. 1;

FIG. 3 is a view showing the spectral-transmissivity characteristics of a bismuth oxide vapor deposition film;

FIG. 4 is an enlarged cross-sectional view of an essential part showing the constitution of a field-emission-type flat panel type image display device according to another embodiment of a display element of the present invention;

FIG. 5 is a plan view of a second control electrode shown in FIG. 4 as viewed from above.

FIG. 6 is a front view for explaining one example of a video display device using the projection type cathode ray tube according to the present invention;

FIG. 7 is an explanatory view showing an example of the inner arrangement of the video display device shown in FIG. 6; and

FIG. 8 is a schematic view for explaining an arrangement example of an optical system of a color projector.

### DETAILED DESCRIPTION OF THE INVENTION

Specific embodiments of the present invention are explained in detail in conjunction with drawings showing the embodiments.

### Embodiment 1

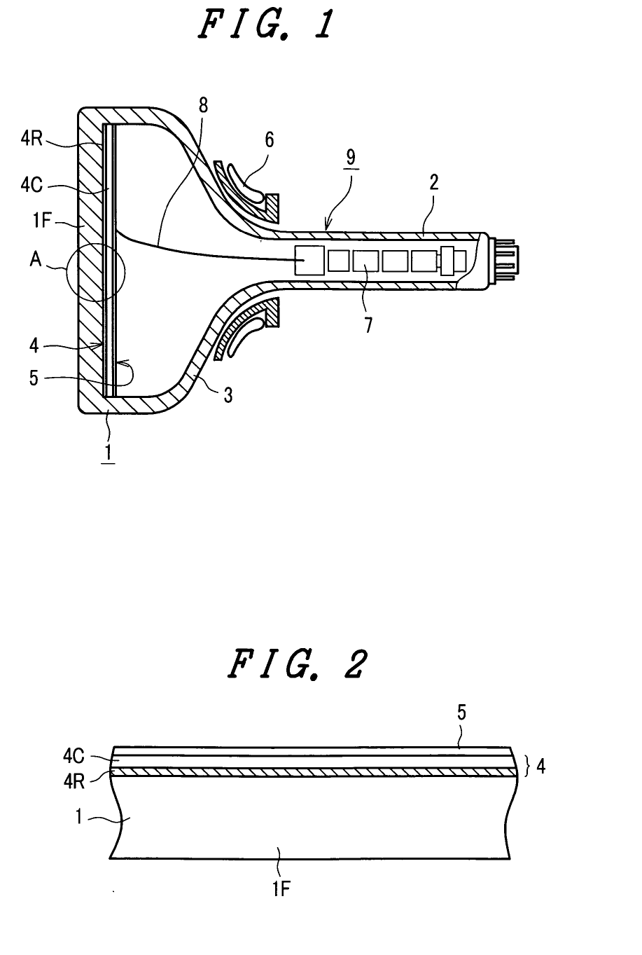

FIG. 1 is a cross-sectional view of an essential part for schematically explaining the constitution of a projection type cathode ray tube according to one embodiment of a display device of the present invention. In the drawing, numeral 1 indicates a panel portion, numeral 1F indicates a face plate, numeral 2 indicates a neck portion, numeral 3 indicates a funnel portion, numeral 4 indicates a phosphor screen, numeral 4C indicates a phosphor layer, numeral 4R indicates a reflection film for reflecting electron beams, numeral 5 indicates an aluminum vapor deposition film, numeral 6 indicates a deflection yoke, numeral 7 indicates an electron gun, numeral 8 indicates electron beams, and numeral 9 indicates a projection type cathode ray tube.

A glass-made vacuum envelope (bulb) which forms the projection type cathode ray tube 9 is constituted of the panel portion 1 which has a large-diameter light transmitting face plate 1F, an elongated cylindrical neck portion 2 which houses the electron gun 7 in the inside thereof, and the funnel portion 3 which connects the panel portion 1 and the neck portion 2.

The panel portion 1 includes the phosphor screen 4 having the two-layered structure which is constituted of the phosphor layer 4C which is formed on an inner surface of the face plate 1F and the reflection film 4R and the aluminum vapor deposition film 5 which is formed on the phosphor screen 4.

Here, the phosphor layer 4C constitutes a green phosphor layer when the projection type cathode ray tube 9 is a projection type cathode ray tube for a green image, the phosphor layer 4C constitutes a blue phosphor layer when the projection type cathode ray tube 9 is a projection type cathode ray tube for a blue image, and the phosphor layer 4C constitutes a red phosphor layer when the projection type cathode ray tube 9 is a projection type cathode ray tube for a red image.

The reflection film 4R is formed between the inner surface of the face plate 1F and the phosphor layer 4C and is configured to exhibit the high reflection characteristics with respect to the electron beams 8 emited from the electron gun 7. The reflection film 4R is a thin film made of a metal compound of bismuth oxide (Bi₂O₃) having an average film thickness of approximately 0.2 μm, for example. The deflection yoke 6 is mounted on an outside of a portion which connects the neck portion 2 and the funnel portion 3, wherein one electron beam 8 emited from the electron gun 7 is deflected for scanning in the given direction by the deflection yoke 6 and, thereafter, is emited to the phosphor screen 4.

An image display operation in the projection type cathode ray tube 9 having the above-mentioned constitution is substantially equal to an image display operation in a known projection type cathode ray tube. Further, an operation of a projection type television device which projects respective display images which are formed by the projection type cathode ray tube for a green image, the projection type cathode ray tube for a blue image, and the projection type cathode ray tube for a red image on a video screen in a synthetic or in a combined state and displays a magnified synthesized color image on the video screen is also equal to an operation of a known type of projection television device and hence, the explanation of both of these operations is omitted.

FIG. 2 is an enlarged cross-sectional view showing the specific structure of a portion A of the face plate 1F and the phosphor screen 4 of the projection type cathode ray tube 9 shown in FIG. 1, wherein parts which are identical with parts described in conjunction with FIG. 1 are given same symbols. In FIG. 2, on the inner surface of the face plate 1F, the reflection film 4R which is formed on the inner surface of the face plate 1F and the phosphor layer 4C which is formed on the reflection film 4R are arranged. In this case, the reflection film 4R is a thin film which has an average film thickness of approximately 0.2 μm and contains bismuth oxide (Bi₂O₃) as a main component thereof. The phosphor layer 4C is formed of any one of the green phosphor layer, the blue phosphor layer, and the red phosphor layer.

The phosphor screen 4 having the above-mentioned constitution is formed in accordance with following steps.

First of all, the bulb structural body which connects the panel portion 1 and the funnel portion 3 or the bulb which is formed of the panel portion 1 and the funnel portion 3 in a non-fused state is prepared. Further, the bismuth oxide (Bi₂O₃) powder or the bismuth oxide (Bi₂O₃) pellet which is formed by compacting the bismuth oxide (Bi₂O₃) powder is prepared. In addition to these steps, a vapor deposition device which is served for vapor-depositing the bismuth oxide (Bi₂O₃) powder or the bismuth oxide (Bi₂O₃) pellet on the inner surface of the face plate 1F of the panel portion 1F is prepared.

Further, a first solution which mixes a trace amount of bariumacetate solution and pure water therein, a second solution which mixes a suspension which suspends green phosphor particles in pure water and potassium silicate (water glass) solution, a third solution which mixes a suspension which suspends blue phosphor particles in pure water and potassium silicate (water glass) solution, and a fourth solution which mixes a suspension which suspends red phosphor particles in pure water and potassium silicate (water glass) solution are respectively prepared.

Next, in the inside of the vapor deposition device, the vapor deposition is performed on the inner surface of the face plate 1F of the panel portion 1 under a reduced pressure of approximately 10⁻⁵ Torr (≈1.33×10⁻⁵ Pa) using the bismuth oxide (Bi₂O₃) powder or the bismuth oxide (Bi₂O₃) pellet as a vapor deposition source. The vapor deposition on the inner surface of the faceplate 1F of the panel portion 1 is performed by placing the vapor deposition source in the inside of the bulb of the bulb structural body which is formed by connecting the panel portion 1 and the funnel portion 1F. Alternatively, the vapor position is performed only on the inner surface of the panel portion 1 and, thereafter, the funnel portion 3 is welded to form the bulb structural body. That is, the reflection film of the present invention is a vapor deposition film.

This reflection film 4R is formed of a metal compound thin film made of bismuth oxide (Bi₂O₃) having a film thickness of approximately 0.2 μm, for example, and obtains approximately 90% of optical transmissivity of white light. Further, since the reflection film 4R is formed by the vapor deposition method, the reflection film 4R is formed of a series of films. Accordingly, the diffusion of light is small.

Subsequently, the processing is advanced to the steps for forming the phosphor layer 4C on the reflection film 4R.

Here, when the projection type cathode ray tube 9 is the projection type cathode ray tube for green image, the first solution is injected into the inside of the face plate 1F of the panel portion 1 of the bulb structural body which forms the reflection film 4R thereon and, thereafter, when a given time lapses from the injection of the first solution, the second solution is injected. The bulb structural body is held still in such a condition for 5 to 10 minutes so as to sediment the green phosphor particles on the inner surface of the face plate 1F, and a green phosphor particle film is formed on the inner surface of the face plate 1F due to a binder action attributed to water glass which constitutes a binder material.

Thereafter, the solution injected into the inside of the bulb structural body is discharged, air is blown off to the green phosphor particle film for drying thus forming the green image phosphor layer 4C on the reflection film 4R. Subsequently, the aluminum vapor deposition film 5 is applied to the green image phosphor layer 4C by known means thus forming the phosphor screen 4 and the aluminum vapor deposition film 5 on the inner surface of the face plate 1F.

Further, when the projection type cathode ray tube 9 is the projection type cathode ray tube for a blue image, in the above-mentioned respective steps, the third solution is injected in place of the injection of the second solution and, then, the blue image phosphor layer 4C is formed on the reflection film 4R by way of steps substantially equal to the above-mentioned steps. Thereafter, the aluminum vapor deposition film 5 is applied to the blue image phosphor layer 4C thus forming the phosphor screen 4 and the aluminum vapor deposition film 5 on the inner surface of the face plate 1F.

Still further, when the projection type cathode ray tube 9 is the projection type cathode ray tube for a red image, in the above-mentioned respective steps, the fourth solution is injected in place of the injection of the second solution and, then, the red image phosphor layer 4C is formed on the reflection film 4R by way of steps substantially equal to the above-mentioned steps. Thereafter, the aluminum vapor deposition film 5 is applied to the red image phosphor layer 4C thus forming the phosphor screen 4 and the aluminum vapor deposition film 5 on the inner surface of the face plate 1F.

The reflection film 4R which is obtained in this manner may preferably be formed of a film which allows at least approximately 80% or more, preferably 90% or more of the light emited from the phosphor layer 4c to pass therethrough.

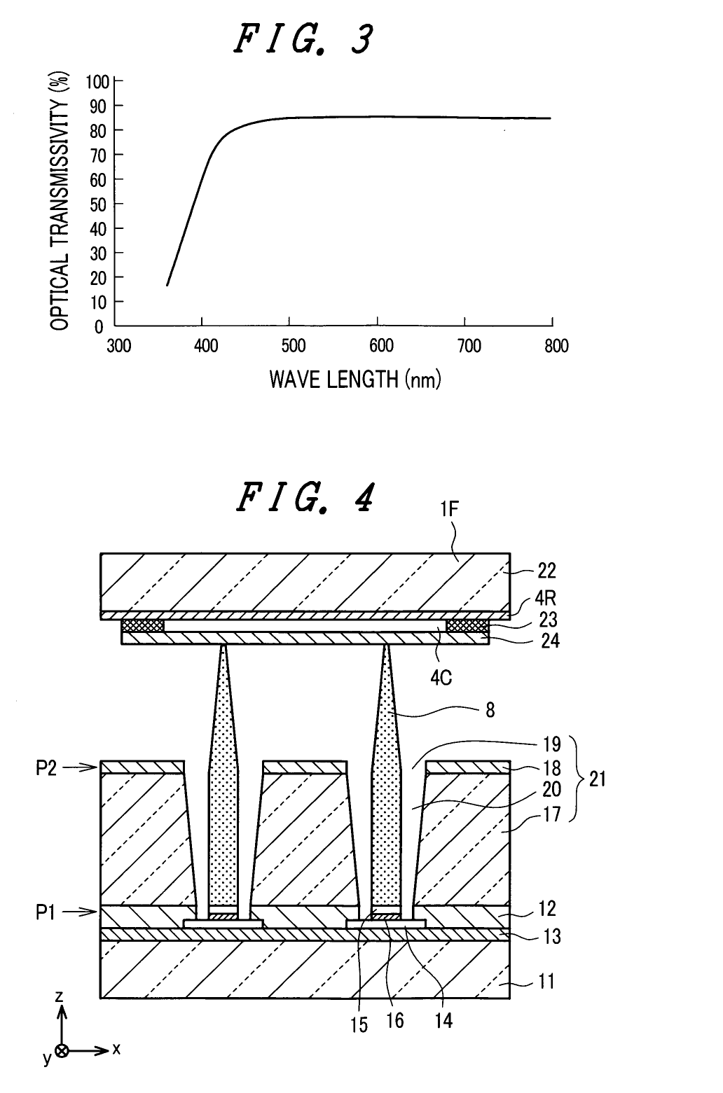

Here, when the bismuth oxide (Bi₂O₃) which constitutes the reflection film 4R is vapor deposited in vacuum, the bismuth oxide (Bi₂O₃) is partially reduced into metal thus giving rise to a possibility that the transparency of the bismuth (Bi) film is largely lowered. In such a case, it is found that when the obtained bismuth (Bi) film is baked at a temperature of 400° C. to 500° C. for one hour, the bismuth (Bi) film is oxidized again so that the transparency is enhanced and recovered after baking. As a result, with respect to the transmissivity, it is possible to obtain the transmissivity of approximately 80% or more as indicated by the spectral-transmissivity characteristics shown in FIG. 3.

In this case, although the average film thickness of the reflection film 4R is set to approximately 0.2 μm, even when the film thickness of the reflection film 4R is set to 0.2 μm or less, it is confirmed that, due to a synergistic effect obtained by the combination of various phosphor layers and various film thicknesses, transmissivity of 87% to 90% can be obtained with respect to the red light emitting phosphor, for example.

On the inner surface of the face plate 1F of the projection type cathode ray tube 9, the reflection film 4R formed of the metal compound thin film made of bismuth oxide (Bi₂O₃) having the average film thickness of approximately 0.2 μm is formed by the vacuum vapor deposition method. The electron beams which pass through the phosphor layer 4C are reflected on the reflection film 4R. The reflected electron beams reenter the phosphor layer 4C and impinge on the phosphor particles. Accordingly, the cathode ray tube of the present invention can largely increase the light emitting quantity from the phosphor particles which constitute the phosphor layer 4C compared with the corresponding light emitting quantity in the known projection type cathode ray tube and the corresponding light emitting quantity of the currently available color cathode ray tube.

Further, in the projection type cathode ray tube 9 having such a constitution, it is possible to allow the electron beams which pass through the phosphor layer 4C to be reflected on the reflection film 4R and to be projected to the phosphor layer 4C again and hence, the density of electron beams 8 which are directly projected to the inner surface of the face plate 1F can be decreased. Further, the cathode ray tube of the present invention can largely reduce the generation of browning of the face plate 1F which occurs due to the projection of the electron beams 8 and hence, the optical transmissivity of the face plate 1F can be largely enhanced compared to the optical transmissivity of the known projection type cathode ray tube. Accordingly, the brightness of a display image in the projection type cathode ray tube can be largely enhanced.

Due to such a constitution, the light emitting quantity from the phosphor layer 4C can be increased and the optical transmissivity of the face plate 1F can be enhanced and hence, it is possible to remarkably increase the brightness of the phosphor screen 4 compared to the brightness of the phosphor screen of the current-available projection type cathode ray tube.

Further, according to the projection type cathode ray tube 9 having such a constitution, there is no possibility that the particles made of bismuth oxide (Bi₂O₃) are coagulated on the panel and hence, it is possible to enhance the optical transmissivity and, at the same time, it is possible to form the uniform film. Further, with the use of bismuth oxide (Bi₂O₃) as the metal compound which constitutes the reflection film 4R, it is possible to form the reflection film 4R which is formed as a thin film at a relatively low cost.

In the above-mentioned embodiment, the explanation is made with respect to an example in which the projection type cathode ray tube is used as a display device. However, the present invention is not limited to the projection type cathode ray tube and it is possible to obtain the exactly same advantageous effect as described above also with respect to a color cathode ray tube by applying this technique to an inner surface of a face plate of a panel portion of the color cathode ray tube. Further, it is also possible to obtain the exactly same advantageous effect as described above by applying this technique to an image display device having an electron beam excited phosphor screen.

### Embodiment 2

FIG. 4 is an enlarged cross-sectional view of an essential part of a flat panel image display device having an electron beam excited phosphor screen for explaining the constitution of another embodiment of the display device according to the present invention. In FIG. 4, parts which are identical with the parts shown in the above-mentioned FIG. 1 are given same symbols and their explanation is omitted. In FIG. 4, numeral 11 indicates a back substrate, numeral 12 indicates first control electrodes, numeral 13 indicates a first control electrode line which supplies electricity to the first control electrodes 12, numeral 14 indicates a lower insulation layer, numeral 15 indicates cathodes which constitute electron sources, numeral 16 indicates cathode lines, numeral 17 indicates a plate-like upper insulation layer, numeral 18 indicates a second control electrode (focusing electrode), numeral 19 indicates electron passing apertures formed in the second control electrode 18 in an elliptical shape, numeral 20 indicates electron passing apertures formed in the upper insulation layer 17 in an elliptical shape, numeral 21 indicates an integral type second control electrode structural body, numeral 22 indicates a face substrate corresponding to a light transmitting panel glass, numeral 23 indicates a black matrix and numeral 24 indicates an anode formed of an aluminum vapor deposition film. Here, reference symbol P1 indicates a first plane arranged parallel to the back substrate 11 and a reference symbol P2 indicates a second plane arranged parallel to the back substrate 11.

The flat panel type image display device according to this embodiment includes, on the above-mentioned first plane P1 on a main surface of the back substrate 11 which is preferably made of glass, a ceramic material or the like, a plurality of cathode lines 16 which extend in the first direction (y direction) and are arranged in parallel in the second direction (x direction) which intersect the first direction. On the cathode lines 16, the cathodes 15 which constitute electron sources are formed at positions where respective pixels (color sub pixels in case of a color display) are arranged. Further, on the above-mentioned first plane P1, the first control electrodes 12 are arranged on the same plane and parallel to the cathode lines 16 in a state that the first control electrodes 12 sandwich at least a portion of the cathode 15 of the cathode line 16. The first control electrodes 12 penetrate the lower insulation layer 14 and are electrically connected with the first control electrode line 13.

Further, on the second plane P2 which is positioned above the first control electrodes 12 and are arranged parallel to the first plane P1, the second control electrode 18 is arranged. The second control electrode 18 is insulated from the first control electrodes 12 by the upper insulation layer 17 which is formed between the first plane P1 and the second control electrode 18. Further, the second control electrode 18 includes the apertures 19 which allow the transmission of the electron beams 8 at portions thereof corresponding to the above-mentioned respective pixels and are formed to cover upper portions of the first control electrodes 12. The apertures 19 have a size which allows the cathodes 15 which are formed on the first plane P1 and portions of the first control electrodes 12 which are arranged close to the cathodes 15 to be exposed. Here, the upper insulation layer 17 is formed except for the cathodes 15 which are formed on the first plane P1 and portions thereof corresponding to the portions of the first control electrodes 12 which are arranged close to the cathodes 15.

Further, electron beam sources for respective pixels are formed at intersecting portions of the cathode lines 16 having the cathodes 15 and the first control electrode lines 13. The cathode lines 16 have lead lines at least one of peripheral sides of the back substrate 11, while the first control electrode line 13 which is connected with the first control electrodes 12 has a lead line on at least another side of the peripheral sides of the back substrate 11. A video signal voltage and a control voltage are respectively supplied via these lead lines. Further, the second control electrode 18 constitutes a so-called focusing electrode and a focusing voltage is supplied to the second control electrode 18 via lead lines not shown in the drawing which are formed outside a display region of the face substrate which will be explained later.

On the other hand, the face substrate 22 is laminated to the back substrate 11 with a given gap therebetween by a sealing frame body not shown in the drawing in the z direction. The face substrate 22 is formed of a light transmitting glass plate. On an inner surface of the face plate 1F of the face substrate 22, the reflection film 4R which is formed of a vapor deposition film made of bismuth oxide (Bi₂O₃) having an average film thickness of approximately 0.2 μm, the phosphor layers 4C and the anode 24 which are defined by the black matrix 23 are formed, wherein the distance between the back substrate 11 and the face substrate 22 is held at a given distance and the inside thereof is evacuated and sealed.

The flat panel image display device having such a constitution is prepared by a process explained hereinafter. First of all, the control electrode lines 13 are formed on the back substrate 11 by a screen printing method which uses a conductive paste preferably formed of a silver paste (hereinafter referred to as a silver paste). Next, on the back substrate 11 on which the control electrode lines 13 are formed, the lower insulation layer 14 is formed over a whole region thereof corresponding to a region in which an image is displayed by a screen printing method which uses a dielectric paste.

On the flat lower insulation layer 14 formed in this manner, the first control electrodes 12 are formed by a screen printing method which uses a silver paste in a state that the first control electrodes 12 are electrically connected with the control electrode lines 13. After baking these first control electrodes 12 by heating, the cathode lines 16 are formed in regions which are sandwiched by the first control electrodes 12 on the lower insulation layer 14 by a screen printing method which uses a silver paste. Further, on these cathode lines 16, the cathodes 15 are formed by a screen printing method which uses a silver paste containing approximately 10% by weight of carbon nanotubes which are pulverized into a size of approximately lm or less and the cathodes 15 are solidified by baking with heat. Here, by setting a film thickness of the first control electrodes 12 to approximately 10 μm and film thicknesses of the cathode lines 16 and the cathodes 15 to approximately 5 μm respectively, surfaces of the first control electrodes 12 and the cathode 15 form a substantially coplanar shape as shown in FIG. 4.

On the other hand, the upper insulation 17 which is arranged over the back substrate 11 on which the above-mentioned various electrodes are formed and the second control electrode 18 which is formed on an upper surface of the upper insulation layer 17 are formed in accordance with a process explained hereinafter. First of all, the upper insulation layer 17 uses an insulation board made of glass, a ceramic material or the like as a base body, and in the insulation board, at positions thereof which respectively face the respective cathodes 15 formed on the cathode lines 16 in an opposed manner, a plurality of elliptical apertures 20 are formed as electron passing holes which allow the electron beams 8 emitted from the cathodes 15 to pass therethrough in the direction toward the inner surface of the face substrate 22. These apertures 20 are formed by a hole forming method which is performed simultaneously with the forming of the insulation board or a forming method using laser radiation after forming the insulation board.

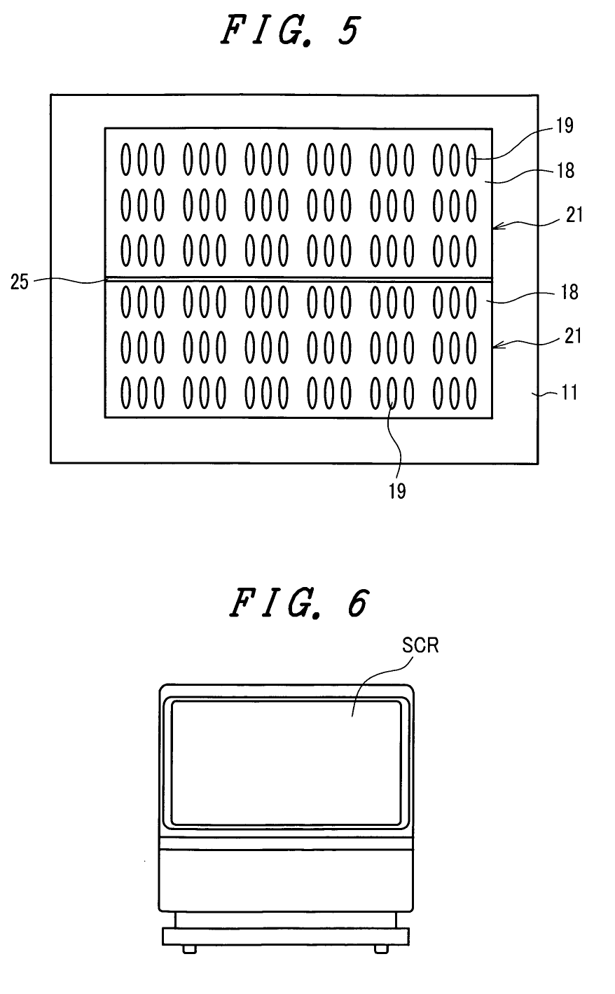

Further, except for the respective apertures 20 formed in the insulation board, on an upper surface (face-substrate-side) of the insulation board, the second control electrode 18 which performs a focusing control of the electron beams 8 which pass through the respective apertures 20 is formed over a whole surface of the insulation board in a plan view of an essential part as viewed from the anode side as shown in FIG. 5. Accordingly, an integral plate-like second control electrode structural body 21 which includes the respective apertures 19 which are communicated coaxially with respective apertures 20 formed in the insulation board is prepared. The second control electrode 18 is formed by applying a conductive metal material such as nickel, for example, using a vapor deposition method, a sputtering method or the like to form a film having a thickness of approximately several 10 μm. Here, the second control electrodes 18 may be formed such that the second control electrode 18 is formed on an upper surface of the insulation board in which respective apertures 20 are formed by applying by a screen printing method which uses a conductive paste and the second control electrode 18 is baked by heating. Since the second control electrode 18 is an only electrode to which a DC voltage is applied and hence, the patterning is unnecessary at the time of preparing the electrodes.

Further, as shown in FIG. 5, to the second control electrodes 18, a conductive spacer 25 for maintaining a distance between the second control electrode 18 and the anode 24 which are arranged to face each other in an opposed manner to a given size is connected. An electrical contact of a low resistance value is required between the second control electrode 18 and the conductive spacer 25. Accordingly, in fixing the conductive spacer 25 to the surface of the second control electrode 18, a material containing metal or a metal component is used. Due to the use of the fixing material having the low resistance value, even when the second control electrode 18 is divided into a plurality of members, due to the fixing by the conductive spacer 25, an electrical contact between the respective second control electrode 18 can be maintained. Accordingly, the insulation board which constitutes a base body for forming the second control electrode 18 may be used in a form that a plurality of insulation boards which do not deteriorate the size accuracy in the longitudinal direction are combined as shown in FIG. 5.

The integral type second control electrode structural body 21 prepared in this manner is arranged to face in an opposed manner on the back substrate 11 on which the cathode lines 16 to the first control electrodes 12 are formed in a state that electrode surfaces of the second control electrodes 18 are directed upwardly (toward the face substrate 22 side) and the respective apertures 19 and the respective cathodes 15 are coaxially aligned with each other. Then, the integral type second control electrode structural body 21 is assembled to the back substrate 11 on which the respective electrodes are formed and is installed by fixing using an inorganic adhesive material or the like, for example. Here, the second control electrode 18 which is formed on the upper surface of the upper insulation layer 17 has the structure in which the second control electrode 18 is connected with a lead line not shown in the drawing which is formed outside the display region of the face substrate 22 which is arranged to face the back substrate 11 so as to supply a focusing voltage.

On the other hand, the face substrate 22 is laminated to the back substrate 11 with a given gap therebetween in the z direction using a sealing frame body not shown in the drawing. The face substrate 22 is preferably formed of a light transmitting glass plate. On an inner surface of the face plate 1F of the face substrate 22, a reflection film 4R formed of a vapor deposition film made of bismuth oxide (Bi₂O₃), a phosphor layer 4C defined by a black matrix 23 and an anode 24 are formed. A space between the back substrate 11 and the face substrate 12 is evacuated to create a vacuum.

The reflection film 4R is formed of a thin film made of a metal compound of bismuth oxide (Bi₂O₃) having an average film thickness of approximately 0.2 μm between the inner surface of the face plate 1F and the phosphor layer 4C and the reflection film 4R possesses the high reflection characteristics with respect to the electron beams 8. Further, the reflection film 4R is formed by a vapor deposition method exactly in the same manner as the process explained in conjunction with the above-mentioned embodiment 1.

In this flat panel type image display device, on the inner surface of the face plate 1F, the reflection film 4R which is formed on the inner surface of the face plate 1F and the phosphor layers 4C of respective colors consisting of green, blue and red which are formed on the reflection film 4R are arranged. The reflection film 4R is a thin film which has an average film thickness of approximately 0.2 μm and contains bismuth oxide (Bi₂O₃) as a main component. The phosphor layers 4C are constituted of the green phosphor layers, the blue phosphor layers and the red phosphor layers.

In the flat panel type image display device having such a constitution, when a video signal voltage is supplied to the cathode lines 16 and a scanning signal voltage is applied to the first control electrodes 12, the electron beams 8 corresponding to the magnitude of the video signal voltage are taken out from the cathodes 15 which constitute the electron sources formed on intersecting portions of the cathode lines 16 and the first control electrodes 12. The electron beams 8 taken out in this manner receive a focusing action with a focusing voltage (DC voltage) which is supplied to the second control electrode 18, are directed to the face substrate 22 with a high voltage supplied to the anode (anode electrode) 24 formed on the face substrate 22 and excite the phosphor layer 4C to emit light having a given wavelength. Particularly, when electron sources which have the IPG (In-Plane-Gate) structure are used, the utilization efficiency of the electron sources is enhanced and hence, it is possible to obtain the image display of high brightness.

In the flat panel type image display device having such a constitution, by forming the reflection film 4R formed of the vapor deposition film made of bismuth oxide (Bi₂O₃) between the inner surface of the face plate 1F and the phosphor screen 4C so as to reflect the electron beams 8 projected to the faceplate 1F, due to the emission of light attributed to the electron beams 8 which are directly projected to the face plate 1F from the phosphor layer 4C and the emission of light attributed to the electron beams which are re-projected to the phosphor layer 4C by the reflection on the reflection film 4R, the light emission quantity is increased. Accordingly, a rate of the electron beams 8 which are directly projected can be reduced and hence, the browning which is generated on the face plate 1F can be reduced whereby the brightness of the display image in the flat panel type image display device can be largely enhanced.

Here, in the above-mentioned respective embodiments, although the explanation has been made with respect to the case in which the thin film made of bismuth oxide (Bi₂O₃) which constitutes the reflection film 4R has the average film thickness of approximately 0.2 μm, the film thickness of the bismuth oxide (Bi₂O₃) which can be used in the present invention is not limited to the average film thickness of approximately 0.2 μm. When the average film thickness is less than 0.01 μm, the electron beams 8 impinge on the face plate 1F and generate the browning on the face plate 1F and hence, it is difficult to obtain the display device which has the bright display image. When the average film thickness exceeds 10.0 μm, the transmissivity of light from the phosphor layer 4C is lowered. Accordingly, it is preferable to set the film thickness of the thin film made of bismuth oxide (Bi₂O₃) to a value which falls within a range of 0.01 μm to 10.0 μm.

Further, in the above-mentioned respective embodiments, although the metal compound thin film which constitutes the reflection film 4R is explained by taking bismuth oxide (Bi₂O₃) as an example, the present invention is not limited to this example and a compound of metal having an atomic number of 70 or more can be used instead of bismuth (Bi). For example, it is possible to use a metal compound of tungsten (W), lead (Pb) or the like, for example.

Further, in the above-mentioned respective embodiments, although the explanation has been made by taking the means which is formed on the inner surface of the face plate 1F by the vapor deposition method as means to form the reflection film 4R, the present invention is not limited to such a case. That is, in place of the vapor deposition method, it is possible to use a thin film forming method such as a sputtering method, a CVD method and the like, for example.

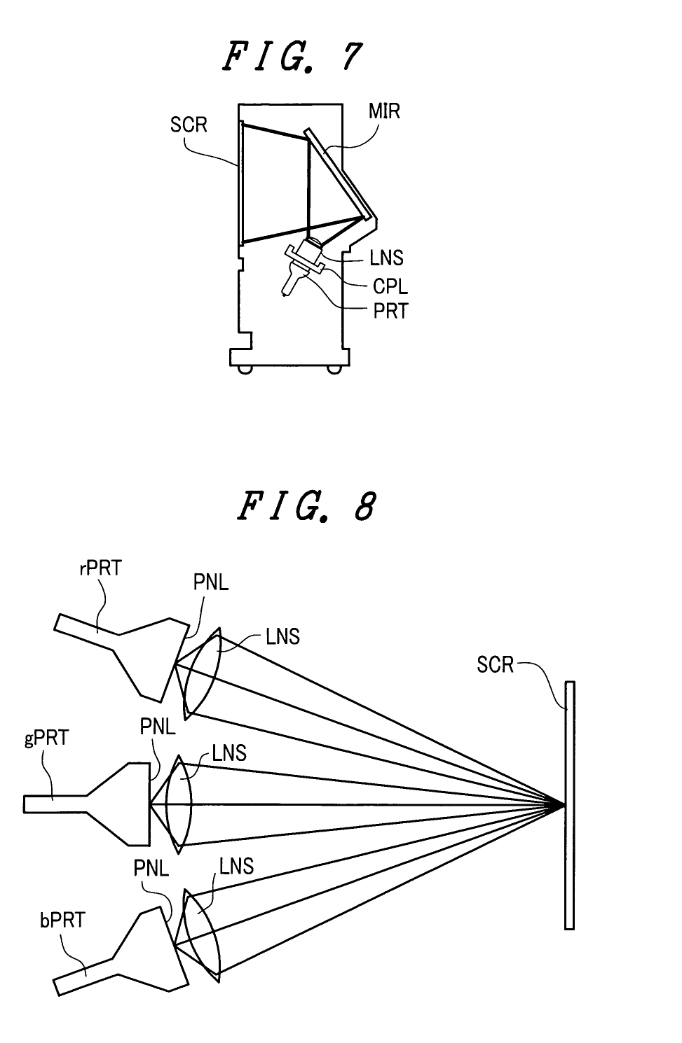

FIG. 6 is a front view for explaining one example of a video display device using the above-mentioned projection type cathode ray tube shown in FIG. 1 as the display device of the present invention and FIG. 7 is an explanatory view showing an example of the inner arrangement of the video display device shown in FIG. 6. FIG. 6 and FIG. 7 show a so-called projection type television receiver set, wherein as shown in FIG. 8, a projection type cathode ray tube for red rPRT, a projection type cathode ray tube for green gPRT, a projection type cathode ray tube for blue bPRT, projection lenses LNS, and a reflection mirror MIR are housed in the inside of the projection type television receiver set. Here, reference symbol CPL indicates couplings which are served for mounting the projection lenses LMS on the projection type cathode ray tubes PRT.

Color images of respective colors which are formed as images on the phosphor layers provided to the panel glasses PNL of three projection type cathode ray tubes PRT are projected to a screen SCR using the projection lenses LNS and the reflection mirror MIR. The projected color images of respective primary colors are synthesized on the screen SCR and a color image is reproduced at the time of performing the above-mentioned projecting. Here, the video display device shown in FIG. 6 and FIG. 7 merely constitutes one example, wherein a portion of the projection type cathode ray tube PRT is divided as a device separate from the screen SCR.

1. A display device comprising:
a vacuum envelope which has a light transmitting panel glass;
a phosphor layer which is formed on an inner surface of the panel glass; and
an electron beam source which is housed in a vacuum envelope and emits electron beams to the phosphor layer,
wherein, a vapor deposition film for reflecting the electron beams is provided between the inner surface of the panel glass and the phosphor layer.

2. A display device according to claim 1, wherein the vapor deposition film is made of a compound of a metal element whose atomic number exceeds 70.

3. A display device according to claim 2, wherein the vapor deposition film is made of bismuth oxide.

4. A display device according to claim 1, wherein the vapor deposition film is formed with a thickness thereof which falls in a range of 0.01 μm to 10.0 μm.

5. A display device according to claim 3, wherein the vapor deposition film is formed with a thickness thereof which falls in a range of 0.01 μm to 10.0 μm.

6. A display device according to claim 1, wherein the vapor deposition film has the optical transmissivity of 80% or more.

7. A display device according to claim 3, wherein the vapor deposition film has the optical transmissivity of 80% or more.

8. A display device according to claim 1, wherein the display device is a projection type cathode ray tube.

9. A display device according to claim 3, wherein the display device is a projection type cathode ray tube.

10. A display device according to claim 1, wherein the display device is a field emission type image display device.

11. A display device according to claim 3, wherein the display device is a field emission type image display device.
